(19) United States
(12) Patent Application Publication
(10) Pub. No.: US 2018/0220688 A1
(43) Pub. Date: Aug. 9, 2018

(54) DRIED FRIES

(71) Applicants: G. NOFAR FOOD AGENCIES LTD., HAIFA (IL); OREGON POTATO CO., Pasco, WA (US)

(72) Inventors: GIL NOFAR, HAIFA (IL); FRANK TIEGS, PASCO, WA (US)

(21) Appl. No.: 15/764,682

(22) PCT Filed: Oct. 2, 2016
(86) PCT No.: PCT/IL2016/051072

§ 371 Date: Mar. 29, 2018

Related U.S. Application Data
(60) Provisional application No. 62/235,591, filed on Oct. 1, 2015.

(51) Int. Cl. A23L 19/18; A23L 19/10; A23B 7/02; A23L 5/10

(52) U.S. Cl. CPC A23L 19/18; A23L 19/105; A23V 2002/00; A23L 5/11; A23B 7/02

(57) ABSTRACT

A fried edible foodstuff comprising less than substantially 250 μg/kg acrylamide. The foodstuff comprises potato pieces, sweet potato pieces and mixtures thereof. Method and process for preparation of fried edible foodstuff.

### CROSS-REFERENCE TO RELATED APPLICATIONS

The present application claims priority to U.S. provisional patent application No. 62/235,591, filed Oct. 1, 2015.

### FIELD OF THE INVENTION

The present invention relates to the preparation of improved fries such as fried potatoes, fried sweet potatoes and the like, and products thereof.

### BACKGROUND OF THE INVENTION

French fries (American English or frites, chips, fries, finger chips, or French-fried potatoes are batons of deep-fried potatoes. French fries are served hot, either soft or crispy, and generally eaten as part of lunch or dinner, or on their own as a snack, and they commonly appear on the menus of fast food restaurants. Sometimes, fries are made with sweet potatoes instead of potatoes.

French fries contain primarily carbohydrates from the potato (mostly in the form of starch) and fat absorbed during the deep-frying process. In food-chains such as Macdonald's and products for home consumption, the fries undergo two frying steps, once wrapping the fries with oil and then freezing them, and then once more immediately before consumption. Typically these fries require lengthy frying to attain a palatable texture, appearance and flavor, a length which unfortunately adversely affects their nutritional value and health risk.

U.S. Pat. No. 5,972,397 describes a method for producing dehydrated potato slices, specifically suitable for making French fries and French fries produced therefrom, which utilizes the application of microwave energy under selected vacuum conditions and a specific range of microwave energy application to produce dried potato slices having a water activity of no more than 0.85. However, the method has apparently not been found practicable and has not been commercialized. One disadvantage of the method of U.S. Pat. No. 5,972,397 is the need to perform batch processing rather than performing continuous processing due to the drying step. U.S. Pat. No. 5,972,397 also states that it is preferable that two frying steps are done, leading to an increased health risk as described below.

French fries contain some of the highest levels of acrylamides of any foodstuff, and concerns have been raised about the impact of acrylamides on human health. For example, a June 2002 report by the Food and Agriculture Organization of the United Nations and the World Health Organization raised concerns over human carcinogenicity based on known carcinogenicity in laboratory animals. The European Chemical Agency added acrylamide to the list of substances of very high concern in March 2010. Acrylamide levels appear to rise as food is heated for longer periods of time, especially from frying.

One aim of the present invention is to provide an improved process—for the healthy preparation of fries.

Another aim of the present invention is to provide an improved fry product with reduced fat and acrylamide levels.

### SUMMARY OF THE INVENTION

According to one aspect of the present invention, there is provided a fried edible foodstuff comprising less than substantially 250 μg/kg acrylamide.

According to one embodiment, the foodstuff comprises less than substantially 150 mg/kg acrylamide.

According to another embodiment, the foodstuff comprises potato pieces, sweet potato pieces and mixtures thereof.

According to another aspect of the present invention, there is provided a process for preparation of fried edible foodstuff, wherein the process comprises: slicing the foodstuff into pieces; precooking the pieces; cooling the pieces; drying the pieces in a preheated oven; reconstituting the pieces in water, and frying the pieces.

According to one embodiment, the drying further comprises heating the pieces for substantially 20-30 minutes at a second stage in the oven set at substantially 185-235° F.

According to another embodiment, the drying further comprises heating the pieces for substantially 60-80 minutes at a third stage in the oven set at substantially 140-200° F.

According to yet another embodiment, the drying further comprises heating the pieces for substantially 170-230 minutes at a fourth stage in the oven set at substantially 95-165° F.

According to a further embodiment, the second stage comprises at least two zones, wherein a difference in temperature between the zones is up to substantially 10° F.

According to yet a further embodiment, the third stage comprises at least two zones, wherein a difference in temperature between the zones is up to substantially 20° F.

According to an additional embodiment, the precooking of the pieces comprises heating the pieces in water for substantially 20-35 minutes at substantially 180-190° F.

According to another embodiment, the cooling is chilling the pieces in water with a temperature in the range of substantially 50-70° F.

According to yet another embodiment, the reconstituting comprises submerging the pieces in water at room temperature or colder temperature.

According to a further embodiment, the frying is for substantially 45-90 s at substantially 320-440° F.

According to yet a further embodiment, the frying is for substantially 50-70 s.

According to an additional embodiment, the drying further comprises subjecting the pieces to air flow from at least one direction.

According to yet an additional embodiment, the drying further comprises subjecting the pieces to air flow from at least two opposite directions.

According to one embodiment, the foodstuff is selected from a group consisting of: potatoes, sweet potatoes and mixtures thereof.

According to another embodiment, fried foodstuff is prepared by the aforementioned process.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

The invention is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts.

The drawings are generally not to scale. For clarity, non-essential elements were omitted from some of the drawings.

FIG. 1 schematically describes a processing of potatoes at a factory.

FIG. 2 schematically summarizes a preparation of potatoes for consumption.

### DESCRIPTION OF PREFERRED EMBODIMENTS

Before explaining at least one embodiment of the invention in detail, it is to be understood that the invention is not necessarily limited in its application to the details set forth in the following description. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”.

The term “consisting essentially of” means that the composition, process or structure may include additional ingredients, steps and/or parts, but only if the additional ingredients, steps and/or parts do not materially alter the basic and novel characteristics of the claimed composition, process or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Unless otherwise defined, all technical and scientific terms used herein have the same meaning as commonly understood by one of ordinary skill in the art to which this invention belongs. Although processes and materials similar or equivalent to those described herein can be used in the practice or testing of the present invention, suitable processes and materials are described below. In case of conflict, the patent specification, including definitions, will control. In addition, the materials and processes are illustrative only and not intended to be limiting.

No attempt is made to show structural details of the invention in more detail than is necessary for a fundamental understanding of the invention, the description making apparent to those skilled in the art how the several forms of the invention may be embodied in practice.

According to one aspect, a process is provided for preparation of fries. The process comprises of blanching the fries; heat-drying the fries; reconstituting the fries in water, and frying the fries for up to 1.5 minutes before consumption.

It is stressed that the process does not involve use of microwave energy but rather the drying is performed in ovens that do not radiate microwaves. In contrast to the method described in U.S. Pat. No. 5,972,397 or the freeze dry method, no effort is made to preserve the shape of the fries or to prevent cooking during the blanching and drying steps by carefully maintaining low temperatures. Rather to the contrary, cooking is actively promoted in order to reduce the time to prepare the fries during the frying final step. The oven dried fries do indeed dramatically change shape following the drying, but surprisingly and most advantageously essentially almost regain their original shape upon being rehydrated and fried.

Compared with commercial preparations of French fries that involve two stages of frying, the processes described herein afford a great reduction in acrylamide production, improvements of the nutritional value, reductions in cooking oil used and less calories per serving. Moreover, whereas the commercially prepared fries contain additives, fewer or no additives are required for the fries prepared according to the processes described herein.

The potatoes or other foodstuff are brought to the factory and then undergo a process which involves the following major steps:
washing the whole potatoes;
peeling the whole potatoes;
scrubbing the whole potatoes;
slicing the potatoes into sticks;
precooking the sticks;
cooling the sticks
drying the sticks in a preheated, multi stage oven at high temperatures;
reconstituting the sticks in water, and
frying the sticks.

Note that freezing of the sticks is excluded from the process, which is an important advantage over commercial preparation methods. The process can easily be performed on a continuous basis.

Blanching is a cooking process wherein the food substance, usually a vegetable or fruit, is briefly cooked and then plunged into iced water or placed under cold running water to halt the cooking process. In the case of French fries, blanching usually refers to pre-cooking the French fries in oil, usually saturated oil, at a lower temperature (https://en.wikipedia.org/wiki/Blanching_(cooking)). The blanching is typically performed at the factory, and a second frying is done at a higher temperature just before consumption.

In contrast, in the presently described processes precooking is performed in a blancher or other suitable apparatus, in water or steam, and no oil is involved in the step. In the presently described process, the sticks are retrograded by being briefly rinsed in cold water, at approximately 50-70° F.

Another important feature of the processes is the heating of the precooked sticks. In preferred embodiments the drying is in preheated ovens set at high temperatures.

The sticks can be reconstituted in cold, warm or boiling water, and then fried just before consumption. The frying duration is typically much shorter than in commercial preparations. As a rule, the time frame is below 1.5 minutes and typically closer to one minute. This produces fried sticks of similar or better quality, and with improved nutritional value than standard French fries.

It should be noted that the potatoes may be cut to pieces in various sizes. Since the drying conditions of the potato pieces depend inter alia on their size, the drying conditions should be suited to their size, as well as the frying conditions.

Furthermore, fried potatoes of the present invention do not loose crispness following frying. It was found that fried potatoes, according to the present invention, remain crispy for example substantially 30 min after frying, and even substantially 1 hour after frying, when maintained at room temperature.

In addition, potatoes fried according to the present invention are dry, and during frying oil is less absorbed by the fried potatoes, as in method is known in the art—rendering them healthier than prior art fried potatoes.

Furthermore, fried potatoes of the present invention may be considered organic, because no additives are added to the potatoes during their processing, including allergens and other potentially detrimental substances that are not added to the fried potatoes.

### Example 1—Preparation at Factory

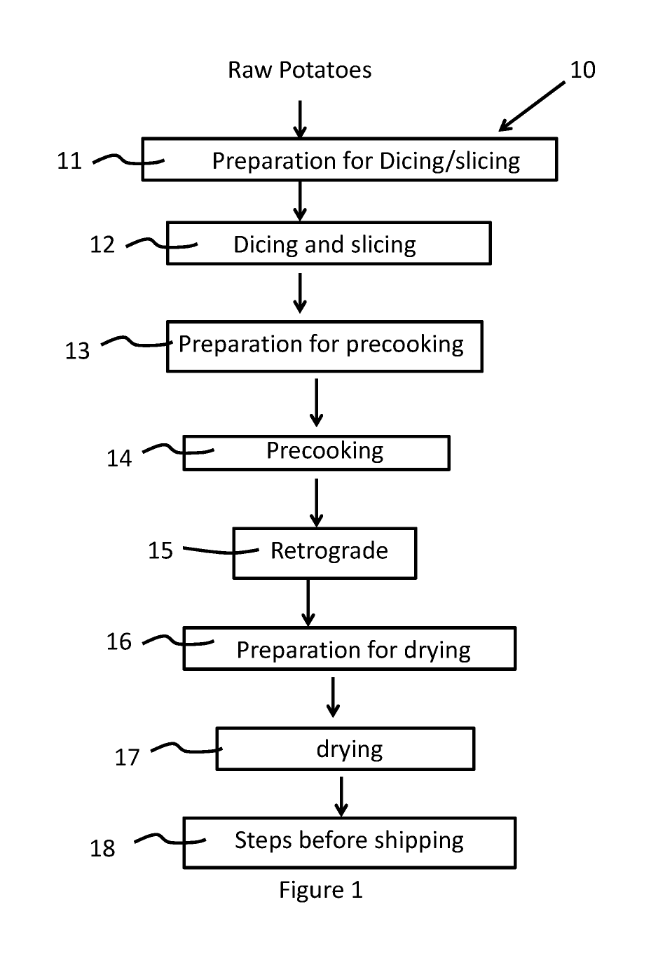

Russet Burbank potatoes were prepared at the factory according to the general method 10 described in the chart of FIG. 1.

Preparing for dicing/slicing 11 may include:

Receiving—Potatoes are unloaded from the trucks and conveyed through a mechanical conveyor that has agitators that remove loose dirt.
Manual foreign material removal—After exiting the mechanical dirt removal equipment, potatoes are inspected by employees who remove vines and grossly defective potatoes.
Distribution bins—Convey potatoes to large distribution bins that provide holding capacity and even flow.
Flume rock removal—Potatoes are transported to a flume that washes the potatoes and has a countercurrent chain in the bottom to remove rocks, after exiting holding bins.
Peeling—The potatoes are subsequently peeled with any peeler known in the art, for example steam peeler, vacuum peeler, caustic peeler, and the like. According to the embodiment of peeling the potatoes with a steam peeler, the peeling lasts substantially 8 to 30 seconds, depending upon the time of year and the thickness of the peel. The steam loosens the peel and most of the peel is removed in the peeling process.
Excess peel removal—The potatoes go through a brush scrubber to remove the remaining peel.
Manual trim/hand inspection—Manually inspecting potatoes after peeling and sorting or trimming as appropriate.
Pumps convey the potatoes to cutters together with employment of a surge tank and a weight belt.
Surge tank—Provides even flow to the cutters.
Weigh belt—Fine tunes the flow of potatoes to the cutters and aligns potatoes so they enter lengthwise into the cutter.

After dicing slicing 12 to the desired size and shape, in preparation for the blanching step 13:

Dewatering sizing shaker—That removes water and small pieces of potato from the line flow.
Defect sorter—Electronically removes defective units.
Sizing shaker—Removes additional undersized units.

Precooking Step 14—the cut potatoes are heated in water, for example at approximately 180-190 degrees Fahrenheit for approximately 20-35 minutes, to essentially fully cook them.

Note that in the prior-art a blanching step is sometimes performed in water or steam; however the blanching in such processes is short, for about 6 minutes only.

The extended blanch time at a higher temperature leads to sluffing, which means that when the cooked product is squeezed between the thumb and fingers, the product becomes a mashed potato. Before squeezing, the corners lose the sharp edges and there is no hardness from the raw to be found in the cooked product.

Retrograding 15: After the product is heated, the product is chilled in water with a temperature ranging from 50-70 degrees Fahrenheit.

Preparing for drying 16: Before drying a pump may convey the precooked potatoes to a dryer.

Dewatering shaker—Removes excess water from the pump loop;
Water vacuum—sucks the free moisture off the potatoes before drying;
Distribution shaker—Aligns the potatoes into the dryer.
Drying 17—Reduces moisture from the potatoes in order to confer a long shelf life to the dried potatoes. According to one embodiment, the moisture level is reduced during drying from for example approximately 80% down to approximately 17% or less; according to another embodiment, down to a range of approximately 6-15%; according to yet another embodiment, down to approximately 10% or less; and according to still another embodiment, down to approximately 9%-8%. The drying is performed by any method and device or system known in the art that comprises a combination of heat and airflow, for example, but not limited to, a belt conveyor dryer; an internal drum dryer—a drum internally containing the cut potatoes, while drying is achieved by applying hot air inside the drum; a carousel dryer, and the like. The entire process takes approximately 4½ hours and is comparable to a convection oven.

Steps before shipping 18 may include:

Line flow control spikes—Rotates the fries at the dryer exit to ensure individual units;
Shaker—Aligns the fries to go through an electronic sorter;
Electronic Sorter—Electronically removes defective fries;
Hand inspection—Manually removes defective fries that weren't detected and removed by the electronic sorter;
Metal detector—Removes any potential metal that may have passed through the process thus far.

Typically the potatoes are cut to an average size of about ¼ to ⅜ of an inch.

The cut potatoes are dried at temperatures ranging from 125-250 degrees Fahrenheit in a multi stage dryer with multiple zones per stage.

An example of a heating program for a belt dryer which typically comprises either 3 or 4 stages: the precooked fries go through sections (stages) A to C and optionally D in the dryer. Each section is made of multiple zones as described below.

Stage A: 20 minutes with zone A1 at 220° F., A2 at 220°, A3 at 220° F.;

Without being limited by theory, it is believed that high heat and air flow are necessary at the initial stage to pull the majority of the moisture from the pieces. If this does not occur in the early stage of the process, the pieces will case harden and moisture cannot be further pulled from the inside of the potato which leads to the pieces not being sufficiently dehydrated and consequently quickly spoiling.

Stage B: 25 minutes with B1 at 205° F., B2 at 200° F.;
Stage C: 70 minutes with C1 at 175° F., C2 at 165° F., and
Stage D: (Optional) 200 minutes with D1 at 145° F., D2 at 115° F.

In some embodiments the pieces can be go through a 4-stage oven which has no heating of stage D.

In general, according to one aspect, the temperature regime and respective times can vary ±15% of these values. A similar heating program can be used for preparation of sweet potatoes, i.e. slight adjustment of the times and temperatures is needed.

According to one embodiment, the fries are subjected to air flow with fans blowing hot air from at least one direction. According to another embodiment, the fries are subjected to air flow with fans blowing hot air from at least two opposite directions; in some embodiments the air flow is from more directions, typically orthogonal to the said opposite directions, with up and down air flow at for example 60 miles per hour (60 Hz in the scale of the motor). Through all stages and zones within the dryer, the process simulates a convection oven. The product is dried solely by use of air movement and heat.

The optimal temperature program and air flow for best results of the fried product, in terms of % solids, levels of acrylamide, flavor and other parameters, depend upon the variety of the potato. However, a leading principle of the treatment is the first stage of the oven, where the temperatures are maximal.

Ranger Russet, Umatilla and other varieties of potatoes may be used, but preferably the potatoes are of a variety that has a high percentage of solids, preferably 23-32% w/w.

Cut potatoes prepared according to the aforementioned procedure absorb much less oil during frying than fried potatoes prepared by a prior art process. Furthermore, it was found that the potatoes fried according to the aforementioned process remained crispy for substantially 30 min after frying, and even substantially 1 hour after frying, when maintained at room temperature.

### Sweet Potatoes

It should be noted that while the aforementioned embodiments are accurate, adjustments can be made to reach the desired cut size of the sweet potato. In addition, the cutting tools referenced below all have the ability to make the desired cut size.

Preparing Sweet Potato Steps:

Wash 1—Thoroughly wash the entire sweet potato.
Peel—Peel the potatoes with any peeler known in the art, for example steam peeler, vacuum peeler, caustic peeler, and the like, in order to loosen the peel.
Scrubber—Run through a brush or roll scrubber.
Cut—Cut the potatoes with either an Urschel, DiversaCut, water knife, by pushing with a piston, or by pushing with air pressure.
Blanch—According to one embodiment, the sweet potatoes are blanched to almost fully cooked (AFC). Because of the high content of sugar in sweet potatoes, it is preferable to conduct the blanching in relatively low temperatures, compared to the bleaching of potatoes that contain lower amounts of sugar, in order to avoid caramelization of the sweet potatoes. According to an exemplary embodiment, the sweet potatoes may be blanched at a temperature in the range of substantially 140-220° F.
Dewatering shaker—Run the sweet potatoes across a dewatering shaker, and then through a water-vacuum suck to take off the surface free moisture of the sweet potato. During this process excess water is removed from the pump loop.
Alignment—Aligning the potatoes into a dryer.
Dry—According to one embodiment, drying is aimed at reducing the moisture down to a range of substantially 7%-9%. According to another embodiment, the drying is aimed at reducing the moisture down to a range of substantially 7%-15%. In this case, the slightly higher humidity level, the shelf life time may be reduced. The drying may be with any dryer known in the art, for example, but not limited to, a belt conveyor dryer; an internal drum dryer, and the like. Once a humidity of substantially 7%-9%—according to one embodiment, or 7%-15% according to another embodiment, has been reached, the sweet potato should be shelf stable.

### Example 2—Reconstitution and Deep Frying

The examples below describe using a product that had 8.6% moisture.

Dried fries weighing 454 g. (originally 30.06% solids) were submerged and kept in a refrigerator for 48 hrs. The mass increased to 1,314 g. after reconstitution. The same amount of dried fries was reconstituted to 1,247 g. fries after duration of 10 hr Dried fries with an initial weight of 227 g were reconstituted to 609 g after being submerged for 2 hr in hot water. The water absorbance was the same regardless of the length of time the dried fries were rehydrated. This was determined by examining the firmness of the center of the fries.

Dried potatoes that were 8.6% moisture were reconstituted by being submerged overnight in water in the refrigerator (˜8 hr). Additionally, the fries were drained to remove excess water from their exterior prior to frying.

After submersion the product had a slightly gray hue, possibly due to the absence of Sodium acid pyrophosphate (SAPP) or other additives which are commonly added to prevent darkening. The slight discoloration disappeared after frying.

Flavoring and/or concentrates such as sweet potato juice concentrate may be added to the water during the reconstitution to enhance the color/flavor of the French fries.

Frying was performed with a fryer, a thermometer and a stopwatch. One and a half gallons of canola oil was used per each 8 oz. of reconstituted fries.

The first frying test was done using cooking oil heated to 375 degrees Fahrenheit for 15 seconds. The visual inspection of the fried potato sticks showed that the oil was apparently not absorbed during the frying stage.

In a second experiment the potato sticks were fried at the same temperature for 30 seconds. There is some absorbance of oil at these conditions, but at a low level.

A third trial was conducted with frying for 45 seconds. Their product had a bit of crispiness and coloration is apparent, however the product is insufficiently golden.

The final batch of rehydrated cut potatoes was fried for a minute and 7 seconds. The latter fried batch was slightly overdone yet had a good bite and crispiness. We estimate that 5 seconds less frying would have been preferable, but frying up to a minute and 20 seconds may be done to increase the crispiness according to the consumer's taste.

The moisture level of the dried cut potatoes, the amounts and proportions of the potatoes to oil, the cut size, the submersion time and the variety of the potatoes all may affect the optimal frying time and temperature, which may be in the range of substantially 320° F.-400-° F.

The latter fried batch had the best texture and color. Together with salt and ketchup, the product was evaluated by a blind test group to be palatably superior to those achieved at the US large fast food chains. The products made using our process were produced with a shorter frying time.

The total solids at the 1 minute and 7 seconds frying time were measured by a moisture analyzer (CEM Smart Trac) to be on average 68.29% solids, compared to a total solid measurement of 65.38% for the products at the fast food chains and 54% for supermarket products.

The total solids indicate the crispiness of the product, which is a desirable characteristic of French fries, and in general French fries having a higher level of solids are more palatable.

Our product has obtained an improved yield compared to products found in super markets.

227 g. of our product decreased to an average of 151 g. after frying.
227 g. of a product purchased at Walmart or others decreased after frying to an average of only 127 g.

We thus found that our yield is 18% more. The solids are on average of 68% whereas the supermarket chains have an average of 54% products for the same type of potato. Ours are thus 26% more solid by average. This is one reason why our product has a very good flavor compared to the other potato sticks in the market.

### Example 3—Pan Frying

A batch of the 8.6% moisture reconstituted product was pan fried at 375 degrees Fahrenheit. Oil was added until the product was immersed in approximately 10-20% oil w/w of the batch. Excellent results were obtained after about a minute to 75 seconds of frying.

In another experiment with the same 8.6% moisture, the sticks were submerged for 1 hour and 20 minutes in warm water and then fried in a similar amount of oil. The product was obtained after 2 minutes of frying.

It was discovered that the fries should be stirred since the upper side is exposed to water vapor, unlike frozen fries. The stirring should be from the start so that the oil can envelop the stick. Only a little stirring is required after the wrapping. Excellent results were obtained after 2-3 minutes frying.

### Example 4—Additional Experiments

Fresh potatoes of the same variety were peeled and also cut to an average of ⅜″ size. The frying was performed as it would be in a home kitchen and took 5.5 minutes. The long frying caused black-brown blemishes at the extremities of the fries made of fresh potatoes.

### Example 5—Snack

The product can be made into a snack as it can be made to have a low water absorbance, which makes it have the correct humidity level for snacks.

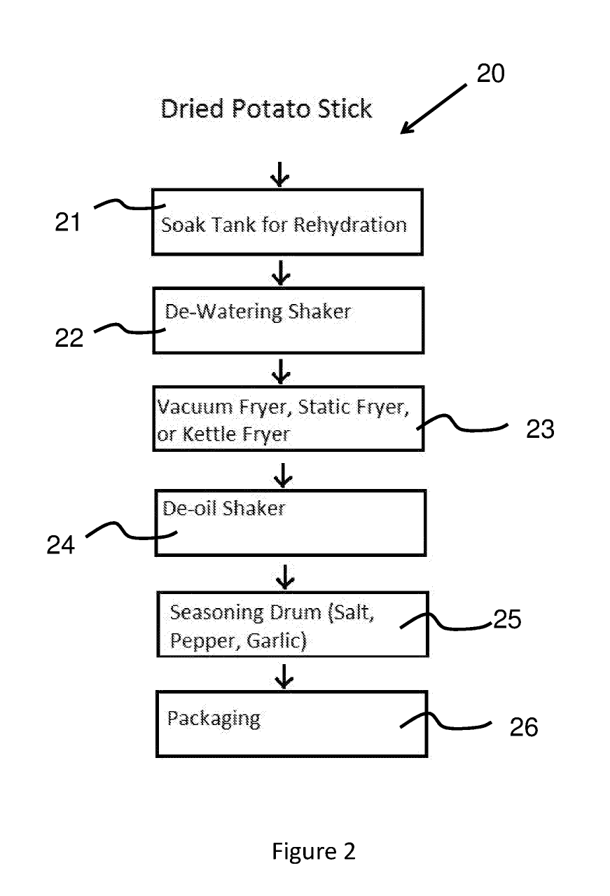

FIG. 2 schematically summarizes an exemplary process for preparing potato snacks 20 according to one embodiment.

Dried potato sticks that have been processed as described above are soaked in a tank 21 for an adequate time to rehydrate the sticks. A shaker 22 removes excess water prior to frying. Various types of fryers 23 can be used to prepare the snack. A de-oil shaker 24 removes excess oil. A seasoning drum 25 applies the flavoring as desired, and the snacks are then packaged 26 into a bag/carton/loose pack prior to shipment.

### Example 6—Comparison of Humidity Levels

In further experiments results with 8.6% moisture and 10.2% moisture level sticks were compared, with the same reconstitution in water conditions and with frying times over a period of 1.5 minutes, 2 minutes and 3 minutes.

The results with the 10.2% moisture product were very similar to those of the 8.6% moisture product at 1 minute frying time. Low humidity is beneficial to the preservation of the product. Frying sticks with either moisture level longer than 1.5 minutes did not improve the product and the color and texture were not as good.

### A Number of Advantages of the Processes and the Products Derived Thereof are Described Below.

The inventive product is better based upon our testing than the fries produced in leading US eateries at 375 degrees Fahrenheit frying temperature.

According to prior art, the total frying time of the potatoes is substantially 5-7 min. In cases when the potatoes are first fried in a production plant and then by a customer, according to prior art the potatoes are fried in the production plant for substantially 2-3.5 min, and then by the customer for additional substantially 2-3.5 min. In cases when the potatoes are fried only by the customer, the frying time according to prior art is substantially 5-7 min. On the other hand, according to the present invention, the potatoes are fried only once, by the customer, for only substantially up to 1.5 min, depending on the size of the cut potatoes.

Accordingly, the frying time in a frying pan, according to the present invention, is also very short, compared to prior art, as described above.

Reconstitution can be done overnight, or by submersion in a warm liquid for up to substantially 2 hours, or by submersion in a cold liquid for more than substantially 2 hours, for example up to 10 hours, or overnight, or more. According to one embodiment, the liquid is water. According to another embodiment, the liquid is brine. According to yet another embodiment, the liquid may further comprise additives, for example by not limited to, flavors, wine, vinegar, Balsamic vinegar, and the like.

Only one frying stage is needed for preparing our product, as opposed to preparation of commercially available products that have two frying steps. Once in solidified fat at the time of manufacture (par fried) in the factory and subsequently frozen and once in oil before consumption.

The dried sticks can be kept at room temperature without need to defrost. Without being bound to theory, it is thought that the oil does not cool as a result of introducing frozen fries and thus there is less absorption of oil by the sticks during their frying.

The short frying time prevents creation of a viscoline ring which is present in fried sticks made from the commercially available frozen fries. This phenomenon occurs when the carbohydrates start to emerge on the surface of the fries and cause black-brown blemishes.

The sticks with reduced moisture levels are dry, and thus there is no need to freeze them during their transporting, and the consumer also does not need to keep them frozen.

In the customs agreements between countries there is a duty tax on frozen or chilled merchandise but usually not on dried products.

The unwanted production of acrylamide is low due to the relatively short frying time. For example, for comparison sake, a batch of French fries produced by McDonalds and a batch of French fries produced by our process were analyzed by an external laboratory. The level of acrylamide in the commercial fries was 155 μg/kg whereas the level in our French fries was only 61 μg/kg.

The nutritional value should be superior due to the short frying time: less oil, and fewer calories. Furthermore, fried potatoes prepared according to the present invention may not contain any additives, for example E numbered additives, allergens, and the like.

The dry sticks can be transported virtually anywhere, even to locations that do not have freezing capabilities such as countries in Africa, and may be used for picnics etc.

The product can be considered natural since the only materials it comprises are oil and potatoes, although SAPP may be added against grayish coloration.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A fried edible foodstuff comprising less than substantially 250 μg/kg acrylamide.

2. The foodstuff of claim 1, wherein the foodstuff comprises less than substantially 150 μg/kg acrylamide.

3. The foodstuff of claim 1, wherein the foodstuff comprises potato pieces, sweet potato pieces and mixtures thereof.

4. A process for preparation of fried edible foodstuff, wherein the process comprises:
slicing the foodstuff into pieces;
precooking the pieces;
cooling the pieces;
drying the pieces in a preheated oven;
reconstituting the pieces in water, and
frying the pieces.

5. The process of claim 4, wherein the drying further comprises heating the pieces for substantially 20-30 minutes at a second stage in the oven set at substantially 185-235° F.

6. The process of claim 5, wherein the drying further comprises heating the pieces for substantially 60-80 minutes at a third stage in the oven set at substantially 140-200° F.

7. The process of claim 6, wherein the drying further comprises heating the pieces for substantially 170-230 minutes at a fourth stage in the oven set at substantially 95-165° F.

8. The process of claim 5, wherein the second stage comprises at least two zones, wherein a difference in temperature between the zones is up to substantially 10° F.

9. The process of claim 6, wherein the third stage comprises at least two zones, wherein a difference in temperature between the zones is up to substantially 20° F.

10. The process of claim 4, wherein precooking the pieces comprises heating the pieces in water for substantially 20-35 minutes at substantially 180-190° F.

11. The process of claim 10, wherein the cooling is chilling the pieces in water with a temperature in the range of substantially 50-70° F.

12. The process of claim 4, wherein the reconstituting comprises submerging the pieces in water at room temperature or colder temperature.

13. The process of claim 4, wherein the frying is for substantially 45-90 s at substantially 320-440° F.

14. The process of claim 13, wherein the frying is for substantially 50-70 s.

15. The process of claim 4, wherein the drying further comprises subjecting the pieces to air flow from at least one direction.

16. The process of claim 15, wherein the drying further comprises subjecting the pieces to air flow from at least two opposite directions.

17. The process of claim 4, wherein the foodstuff is selected from a group consisting of: potatoes, sweet potatoes and mixtures thereof.

18. Fried foodstuff prepared by the process of claim 4.
